(19) United States
(12) Patent Application Publication
(10) Pub. No.: US 2004/0159712 A1
(43) Pub. Date: Aug. 19, 2004

(54) 6-To-3 bit carry-save adder

(76) Inventors: Joel Hatsch, Unterhaching (DE); Winfried Kamp, Munchen (DE); Siegmar Koppe, Munchen (DE); Ronald Kunemund, Dietramszell (DE); Eva Lackerschmid, Munchen (DE); Heinz Soldner, Bruckmuhl-Heufeldmuhle (DE)

Correspondence Address: Andreas Grubert, Baker Botts L.L.P., One Shell Plaza, 910 Louisiana, Houston, TX, 77002-4995, US

(21) Appl. No.: 10/735,956

(22) Filed: Dec. 15, 2003

Related U.S. Application Data
(63) Continuation of application No. PCT/DE02/02088, filed on Jun. 7, 2002.

(30) Foreign Application Priority Data
Jun. 25, 2001 (DE) 101 30 483.8

(51) Int. Cl. G06K 21/06

(52) U.S. Cl. 235/495

(57) ABSTRACT

A carry-save adder for adding bits of the same weight comprises six inputs (I0, I1, . . . , I5) for receiving six bits of in each case the same weight w, to be added. The adder has an output (S) for a sum bit of weight w and two outputs (C0, C1) for two carry bits of weights 2w and 4w.

### CROSS REFERENCE TO RELATED APPLICATION

This application is a continuation of copending International Application No. PCT/DE02/02088 filed Jun. 7, 2002 which designates the United States, and claims priority to German application DE101 30 483.8 filed Jun. 25, 2001.

### TECHNICAL FIELD OF THE INVENTION

The invention relates to a carry-save adder for adding a plurality of bits of the same weight.

### DESCRIPTION OF THE RELATED ART

Carry-save (CS) adders are known in the technology and are implemented by means of electrical circuits in the form of monolithically integrated chips. The most frequently used CS adder is the 3-to-2 bit full adder which has three (interchangeable) inputs of the same weight and two outputs in the form of a sum bit and a carry bit.

To add more than three bits of the same weight, a wallace tree (WT) adder is frequently used. A WT adder is a multistage adder which reduces the number of bits to be added in each stage. The individual stages of a WT adder are built up from 3-to-2 CS full adders arranged in parallel with one another. With each stage, the number of full adders needed for this stage is reduced.

In U.S. Pat. No. 5,504,915, a modified WT adder is described which contains 5-to-3 adders in addition to the 3-to-2 CS full adders. The 5-to-3 adders in each case have four inputs for bits to be added and one input for a carry bit and two outputs for two sum bits and one output for a carry bit.

### SUMMARY OF THE INVENTION

In the text which follows, CS adders are understood to be bit adders having inputs of logically equal weight. The invention is based on the object of creating a CS adder which can be used in many ways and is not very complex. In particular, the CS adder should require little effort of implementation and enable an adder tree having few stages to be implemented. Furthermore in particular, short signal transit times and low current consumption are aimed for.

The objects forming the basis of the invention can be achieved by a carry-save adder for adding bits of the same weight, comprising six inputs for receiving six bits of in each case the same weight w, which are to be added, one output for a sum bit of the weight w and two outputs for two carry bits of the weights 2w and 4w, and three adder subblocks which are arranged in parallel with one another and are not interconnected, wherein the first adder subblock generates the sum bit, the second adder subblock generates the carry bit of weight 2w and the third adder subblock generates the carry bit of weight 4w, each adder subblock being built up from logic gates.

A and in particular each adder subblock can be implemented from a maximum of three series-connected logic gate stages. The first adder subblock may comprise in the first stage three XOR gates, in the second stage one XOR gates receiving input signals from the first two XOR gates of the first stage and in the third stage one XOR gate which receiving input signals from the XOR gate of the second stage and from the third XOR gate of the first stage. The second and third adder subblock each may comprise in the first stage a plurality of NAND gates generating a plurality of output signals, in the second stage a plurality of AND gates combining the signals from the first stage generating three output signals and in the third stage one NAND gate combining the three signals from the second stage.

The object can furthermore be achieved by a carry-save adder for adding bits of the same weight, comprising six inputs for receiving six bits of in each case the same weight w, which are to be added, one output for a sum bit of the weight w and two outputs for two carry bits of weight 2w and 4w, and three adder subblocks connected in parallel with one another and not interconnected, wherein the first adder subblock generates the sum bit, the second adder subblock generates the carry bit of weight 2w and the third adder subblock generates the carry bit of weight 4w, and each adder subblock consists of a multitransistor circuit which cannot be resolved into logic gates, wherein in the multitransistor circuit which forms the adder subblock for calculating the sum bit, one input drives two and the remaining inputs drive four transistors.

In the multitransistor circuit which forms the adder subblock for calculating the carry bit of weight 2w, a first input may drive two transistors, a second and a third input in each case may drive four transistors, a fourth input may drive six transistors and a fifth and a sixth input in each case may drive eight transistors. In the multitransistor circuit which forms the adder subblock for calculating the carry bit of weight 4w, a first and a second input in each case may drive two transistors, a third and a fourth input in each case may drive four transistors and a fifth and a sixth input in each case may drive six transistors. The carry-save adder may further comprise a charging circuit which is connected to the multitransistor circuit, in such a manner that it is discharged via the latter in dependence on the bits present at the inputs of the adder.

Due to its six inputs of the same type, the 6-to-3 bit CS adder according to the invention can add six bits in one adder stage. The 6-to-3 CS adder according to the invention is built up from three adder subblocks arranged in parallel with one another. In this arrangement, a first adder subblock generates the sum bit of weight w, a second adder subblock generates the carry bit of weight 2w and a third adder subblock generates the carry bit of weight 4w. In addition, each adder subblock is built up from logic gates. The term “logic gate” here designates the basic elements of digital circuits, i.e. AND gate, OR gate, XOR gate (exclusive-OR gate), NAND gate (inverted AND gate), NOR gate (inverted OR gate) and inverter.

By outputting two carries of different weight, the possibility of representing three output signals for the simultaneous addition of six input bits of the same weight is utilized. Compared with conventional solutions for adding six input bits consisting of cascaded 3-to-2 CS adders, less wiring complexity, faster switching times and lower power consumption can be achieved due to this single-stage form (with respect to the cascading of adder chips).

Each adder subblock is preferably implemented from a maximum of three cascaded logic gate stages, so that all output bits are already available at the same time after three gate delays (inverters are not taken into consideration in counting the logic gate stages).

According to a second aspect of the invention, the 6-to-3 bit CS adder according to the invention is distinguished by the fact that it is built up from three adder subblocks arranged in parallel with one another, which are not interconnected, a first adder subblock generating the sum bit, a second adder subblock generating the carry bit of weight 2w and the third adder subblock generating the carry bit of weight 4w, and each adder subblock consisting of a multitransistor circuit which cannot be resolved into a plurality of logic gates (according to the above definition). In the multitransistor circuit which forms the adder subblock for calculating the sum bit, one input drives two and the remaining inputs drive four transistors. Each adder subblock thus forms an individual independent “complex gate” without internal logic gate structure which, moreover, is independent of the other adder subblocks. As a result, particularly fast and space- and current-saving circuits can be implemented, since the number of transistors of such circuits can be kept smaller than in the case of circuits designed at logic gate level.

A particularly preferred embodiment of such a carry-retaining adder comprises a charging circuit which is connected to the respective multitransistor circuit in such a manner that it is discharged via the latter in dependence on the bits present at the inputs of the adder. This design of the adder according to the invention, which follows the concept of dynamic circuit design, minimizes the power requirement of the adder.

### BRIEF DESCRIPTION OF THE DRAWINGS

In the text which follows, the invention will be described by means of exemplary embodiments and referring to the drawing, in which:

FIG. 1 is a circuit diagram of a 3-to-2 CS adder at gate level according to the prior art;

FIG. 2 is a circuit diagram of a NAND gate at transistor level according to the prior art;

FIG. 3 is a WT adder which is built up from cascaded 3-to-2 CS adders according to the prior art;

FIG. 4 is a diagrammatic representation of a 6-to-3 CS adder according to the invention;

FIG. 5 is a truth table for a 6-to-3 CS adder according to the invention;

FIG. 6 is a block diagram of a 6-to-3 CS adder according to the invention;

FIG. 7 is a block diagram of a first adder subblock ADD-S from FIG. 6 according to a first exemplary embodiment of the invention;

FIG. 8 is a block diagram of a second adder subblock ADD-C0 from FIG. 6 according to the first exemplary embodiment of the invention;

FIG. 9 is a block diagram of a third adder subblock ADD-C0 from FIG. 6 according to the first exemplary embodiment of the invention;

FIG. 10 is a block diagram of a first adder subblock ADD-S from FIG. 6 according to a second exemplary embodiment of the invention;

FIG. 11 is a block diagram of a second adder subblock ADD-C0 from FIG. 6 according to the second exemplary embodiment of the invention; and

FIG. 12 is a block diagram of a third adder subblock ADD-C1 from FIG. 6 according to the second exemplary embodiment of the invention.

### DETAILED DESCRIPTION OF THE PREFERRED EMBODIMENTS

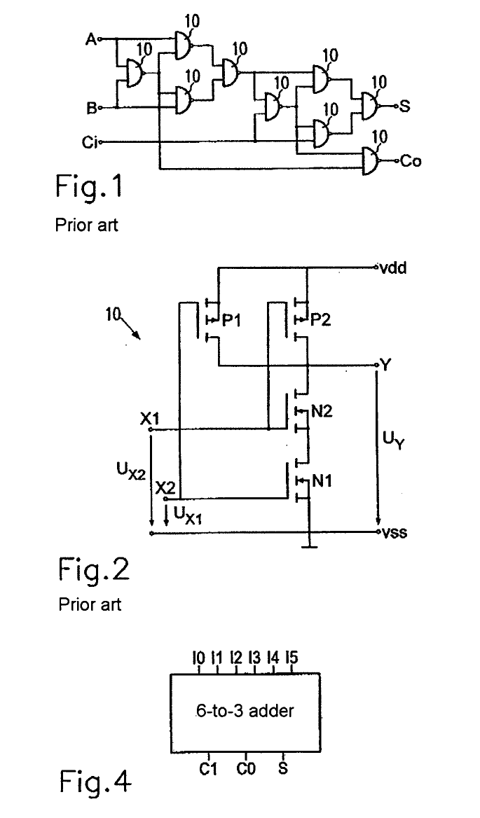

FIG. 1 shows a 3-to-2 CS full adder which is built up exclusively from NAND gates 10 having two inputs. The 3-to-2 CS full adder has three inputs A, B, Ci (carry in) and two outputs S, Co (carry out). The three inputs have the same weight, the output S outputs the sum bit of the weight of the inputs and the output Co outputs the carry bit of twice the weight. In contrast to the inputs A, B, Ci, the outputs S and Co can thus not be interchanged. In this circuit, six gate delays are needed for calculating the result.

FIG. 2 shows the transistor circuit of a NAND gate 10 in CMOS technology according to the prior art. The two inputs of the NAND gate 10 are designated by X1, X2, the output of the NAND gate 10 is designated by Y, the reference potential is designated by vss and the operating voltage is designated by vdd. The NAND gate 10 consists of two series-connected N-channel field effect transistors N1, N2 and two parallel-connected P-channel field effect transistors P1, P2. The output voltage U_{Y} is 0 V only when both N-channel field effect transistors N1, N2 are conducting. This is the case when the relation U_{X1}=U_{X2}=vdd applies to both input voltages U_{X1}, U_{X2}. With U_{X1}=0 or U_{X2}=0, an N-channel field effect transistor N1, N2 is cut off and a P-channel field effect transistor P1, P2 conducts so that U_{Y}=vdd.

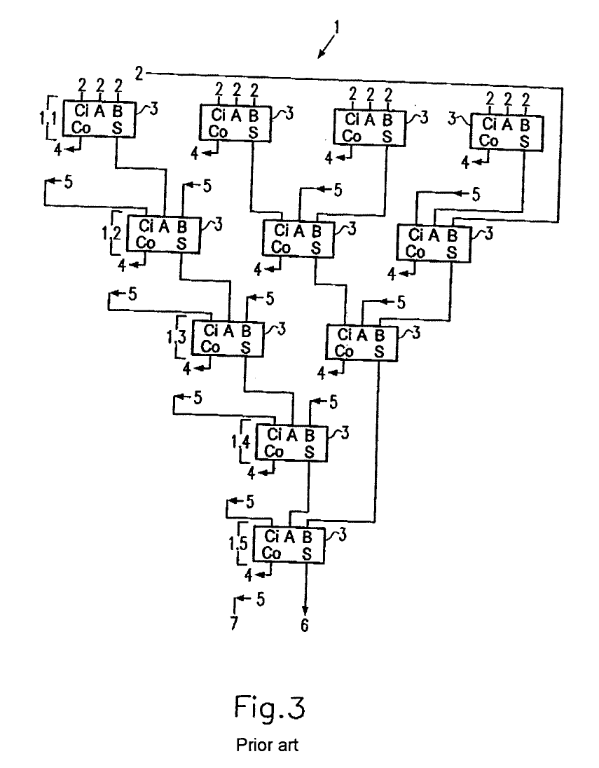

FIG. 3 shows a five-stage WT adder 1 for adding 13 input bits 2 of the same weight according to the prior art.

The WT adder 1 comprises a total of 11 3-to-2 CS full adders 3 which are built up, e.g. according to FIGS. 1 and 2.

The five stages 1.1, 1.2, 1.3, 1.4, 1.5 of the WT adder 1 comprise 4, 3, 2, 1 and, respectively, one 3-to-2 CS full adders 3. The 13 inputs of the WT adder 1 are implemented by means of the 12 inputs 2 of the first stage 1.1 and one input 2 of the second stage 1.2.

Whereas the outputs S of the first stage 1.1 are in each case supplied to inputs of the 3-to-2 CS full adder 3 of the second stage 1.2, the four outputs Co which provide a carry bit 4 are supplied to a second stage of a WT adder (not shown) for adding a bit set having the next highest weight. Analogously, the 3-to-2 CS full adders 3 of the second stage 1.2 in each case receive one or two carry bits 5 which are output by a first stage of a WT adder (also not shown) for a bit set having the next lowest weight.

This principle is continued over the second 1.2 and third 1.3, third 1.3 and fourth 1.4 and fourth 1.4 and fifth 1.5 stage of the WT adder 1. The output of the WT adder is represented by a sum bit 6 and a partial carry bit 7 which originates from the fifth stage of the WT adder 1 of next lowest weight.

FIG. 4 shows a diagrammatic representation of a 6-to-3 CS adder according to the invention. The adder has the inputs I0, I1, I2, I3, I4, I5 and the outputs S, C0, C1. The addition of six bits comprises a range of values of between 0 and 6. The three outputs of the 6-to-3 CS adder represent the sum of the bits present at the inputs in binary coded form. The output S for the sum bit has the same weight as the set of input bits I0 to I5. The output C0 is a carry output which has a weight which is higher by the factor 2 than the output S for the sum bit. The output C1 is also an output for a carry bit, but with a weight which is again increased by the factor 2 compared with the output C0. In other words, outputs S, C0 and C1 have the weights 2⁰, 2¹ and 2² referred to the weight of the bit set at the input of the 6-to-3 CS adder.

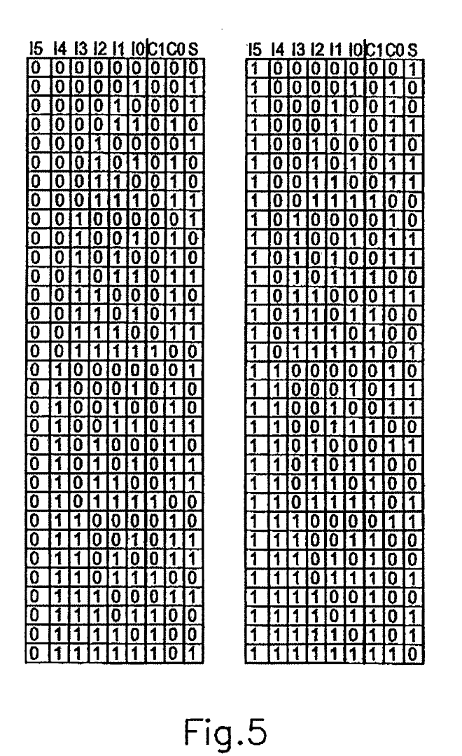

FIG. 5 reproduces the truth table of a 6-to-3 CS adder.

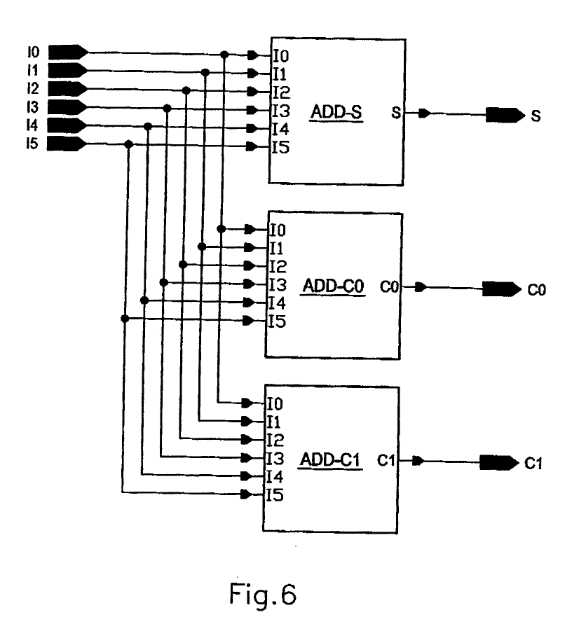

FIG. 6 shows illustratively the configuration of a 6-to-3 adder according to the invention. The six equivalent inputs of the 6-to-3 CS adder are again designated by the reference symbols I0, I1, I2, I3, I4, I5.

The 6-to-3 CS adder comprises three adder subblocks which are designated by the reference symbols ADD-S, ADD-C0 and ADD-C1. Each adder subblock ADD-S, ADD-C0, ADD-C1 has the six inputs I0, I1, I2, I3, I4, I5. With the exception of the input coupling, the adder subblocks ADD-S, ADD-C0, ADD-C1 are not interconnected.

The adder subblock ADD-S outputs the bit of weight 2⁰ at its output S. The corresponding outputs C0 and C1 of the second and third adder subblocks ADD-C0 and ADD-C1 in each case output the bit of weight 2¹ (output C0) and, respectively, the bit of weight 2² (output C1).

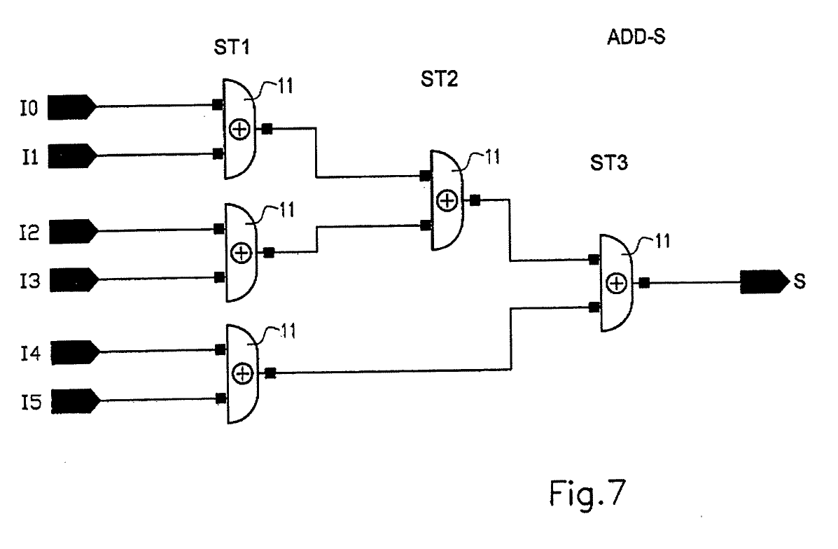

FIGS. 7 to 9 show possible implementations of the gate structures of the individual adder subblocks ADD-S, ADD-C0 and ADD-C1 according to a first exemplary embodiment of the 6-to-3 CS adder according to the invention. In this exemplary embodiment, each adder subblock ADD-S, ADD-C0 and ADD-C1 is built up from individual logic gates which are arranged in a number of cascaded gate stages. According to the language used here, a gate stage contains exactly one logic gate such as, for example, XOR, NAND, etc. or a parallel arrangement of such logic gates. Inverters do not form gate stages.

FIG. 7 illustrates the gate structure of the adder subblock ADD-S. Inputs I0, I1, . . . , I5 are connected in pairs to the in each case two inputs of a total of three XOR gates 11 of the first stage ST1 of the adder subblock. The second stage ST2 (at gate level) of the adder subblock ADD-S is implemented by an XOR gate 11. The two inputs of this gate are formed by the two outputs of two XOR gates 11 of the first stage ST1.

A third and last stage ST3 of the adder subblock ADD-S is implemented by a further single XOR gate 11 which is fed by the output of the XOR gate 11 of the second stage ST2 and the output of the remaining gate 11 of the first stage ST1. The output of the XOR gate 11 of the third stage ST3 is the sum bit output of the 6-to-3 CS adder.

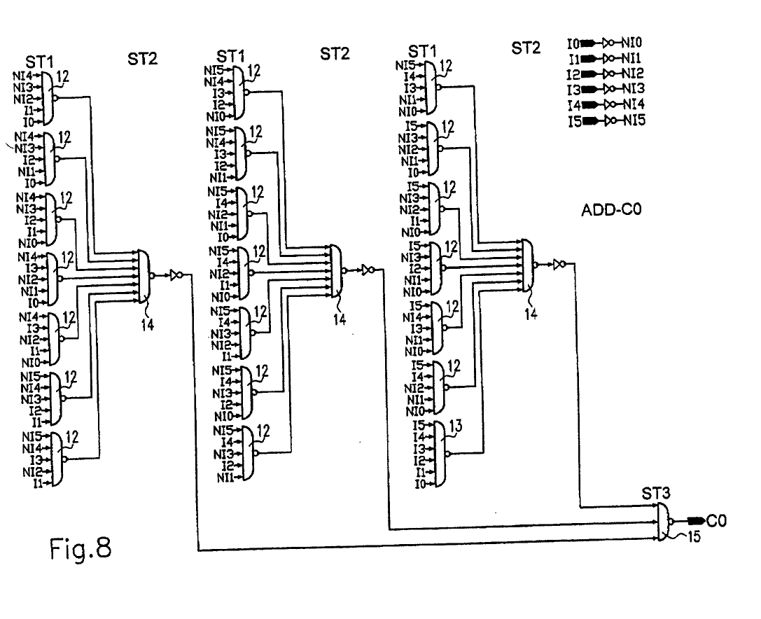

FIG. 8 shows the detailed configuration of the adder subblock ADD-C0. It also consists only of three stages ST1, ST2 and ST3 (the inverters represented by triangular symbols in the drawing are not counted as stages, as already mentioned). The first stage ST1 is formed from 20 NAND gates 12 having in each case five inputs and one NAND gate 13 having six inputs, the second stage ST2 comprises three NAND gates 14 having in each case seven inputs and the third stage ST3 is formed by a NAND gate 15 having three inputs. The output of the NAND gate 15 of the third stage ST3 implements the output C0 of weight 2¹ of the 6-to-3 CS adder from FIG. 4.

The interconnection of the individual NAND gates 12 to 15 of the three stages ST1-3 of the adder subblock ADD-C0 is explained by the reference symbol specified in FIG. 8. In this figure, NI0 to NI5 designate the inverted inputs I0 to I5. This is shown symbolically in the top right-hand part of FIG. 8.

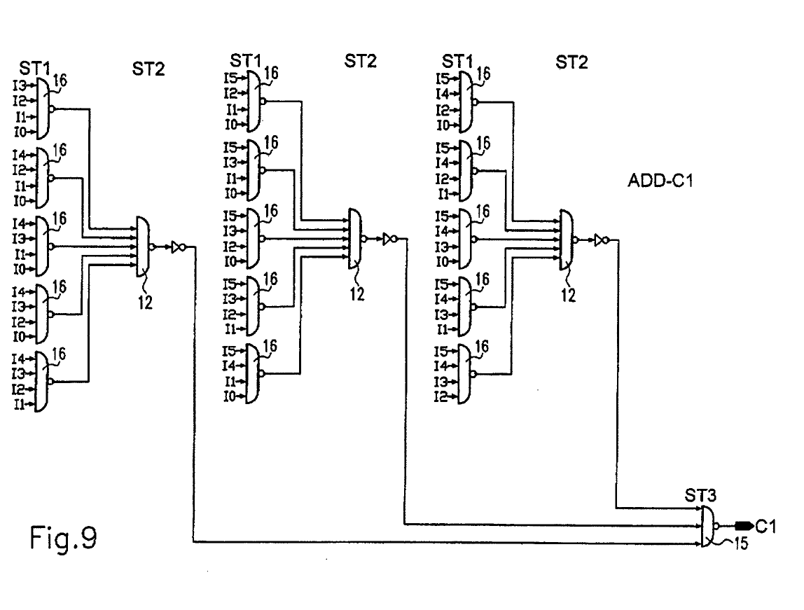

FIG. 9 shows the configuration of the adder subblock ADD-C1 from FIG. 6 according to the first exemplary embodiment at gate level. Again there are three stages ST1, ST2 and ST3. The first stage ST1 comprises 15 NAND gates 16 having in each case four inputs, the second stage ST2 comprises three NAND gates 12 having in each case five inputs and the third stage ST3 comprises one NAND gate 15 having three inputs. The interconnection of the individual stages ST1, ST2, ST3 and the connections to the in each case four inputs of the NAND gates 16 of the first stage ST1 can be seen in FIG. 9 with the aid of the reference symbols. As can be seen, all inputs are driven in a non-inverted manner.

It becomes clear that the 6-to-3 CS adder explained in FIGS. 6 to 9 manages with only three stages ST1, ST2 and ST3 at (logic) gate level for adding six bits.

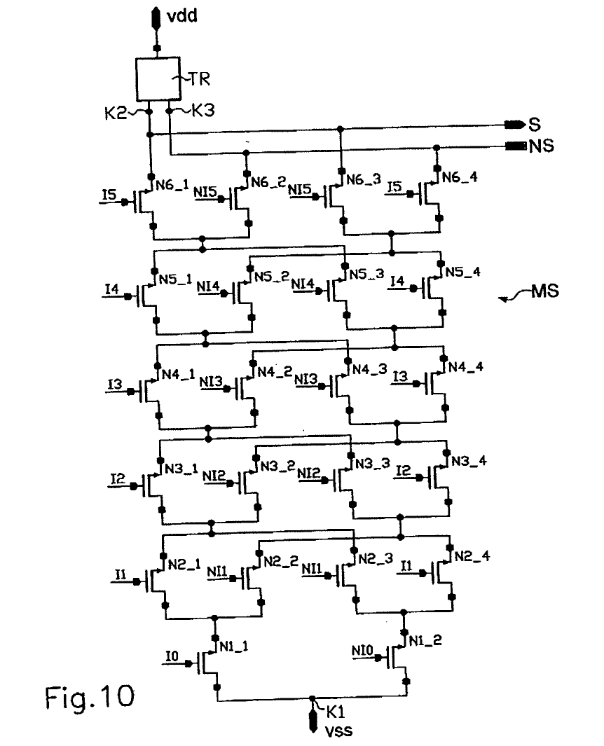

FIGS. 10 to 12 show the configuration of the adder subblocks ADD-S, ADD-C0 and ADD-C1, shown in FIG. 6, according to a second exemplary embodiment of the invention. The second exemplary embodiment of the invention essentially differs from the first exemplary embodiment in that the individual adder subblocks ADD-S, ADD-C0 and ADD-C1 are in each case built up from a multitransistor circuit which cannot be split into individual logic gates. The logic functions of these multitransistor circuits are determined by the circuit configuration at transistor level.

The multitransistor circuit of the adder subblock ADD-S is designated by MS, the multitransistor circuit of the adder subblock ADD-C0 is designated by MC0 and the multitransistor circuit of the adder subblock ADD-C1 is designated by MC1.

All multitransistor circuits MS, MC0 and MC1 have a junction K1 which is connected to the reference voltage vss. They also have in common that they are connected to a driver circuit TR in two junctions K2 and K3. The driver circuit TR is supplied with the operating voltage vdd.

A further commonality consists in that all multitransistor circuits MS, MC0, MC1 have inverted bit outputs NS and NC0 and NC1, respectively, (not shown in FIG. 6), in addition to their respective bit outputs S and C0 and C1, respectively. The junction K2 is connected to the respective non-inverted bit output S, C0, C1 and the junction K3 is connected to the respective inverted bit output NS, NC0, NC1.

According to FIG. 10, the multitransistor circuit MS comprises a total of 22 N-channel transistors which are driven via their base either with the inputs I0, . . . , I5 or the corresponding inverted inputs NI0, . . . , NI5.

Two transistors N1_1, N1_2 allocated to the inputs I0/NI0 are connected with their source terminals to the reference voltage vss and feed the remaining multitransistor circuit MS with their drain terminals. This circuit exhibits for each of the inputs I1/NI1, . . . , I5/NI5 in each case four N-channel transistors N2_1, . . . , N2_4 and, respectively, N3_1, . . . , N3_4 and, respectively, N4_1, . . . , N4_4 and, respectively, N5_1, . . . , N5_4 and, respectively, N6_1, . . . , N6_4. The drain terminals of the transistors Ni_1 and Ni_3 are connected to one another and are connected to the source terminals of the transistors N(i+1)_1 and N(i+1)_2 and, on the other hand, the drain terminals of the transistors Ni_2 and Ni_4 are connected to one another and are connected to the source terminals of the transistors N(i+1)_3 and N(i+1)_4, i=1, . . . , 5.

At the output end, the junction K2 is connected to the drain terminals of the transistors N6_1 and N6_3 and the junction K3 is connected to the drain terminals of the transistors N6_2 and N6_4. In this arrangement the transistors Ni_1 and Ni_4 are in each case driven non-inverted and the transistors Ni_2 and Ni_3 are in each case driven inverted by the relevant input.

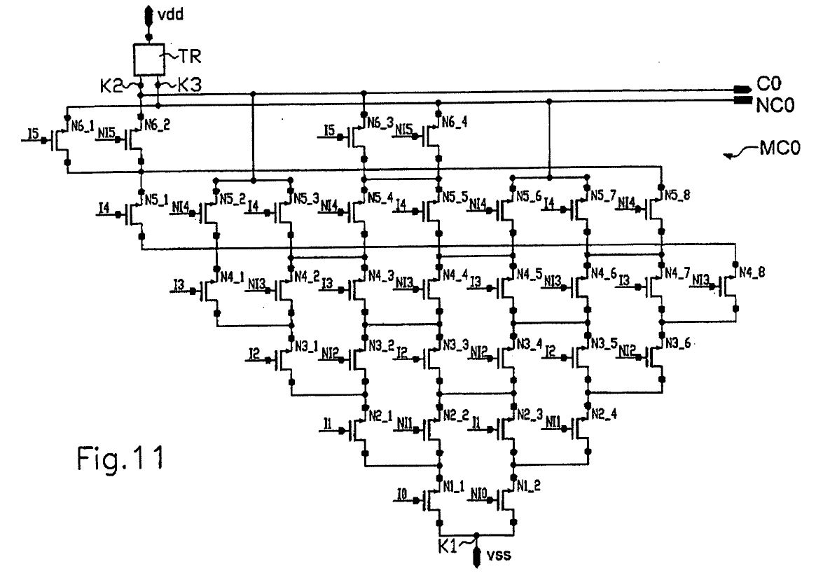

According to FIG. 11, the multitransistor circuit MC0 exhibits two N-channel transistors N1_1 and N1_2 allocated to the inputs I0/NI0, four N-channel transistors N2_1, . . . , N2_4 allocated to the inputs I1/NI1, six N-channel transistors N3_1, . . . , N3_6 allocated to the inputs I2/NI2, eight N-channel transistors N4_1, . . . , N4_8 allocated to the inputs I3/NI3, eight N-channel transistors N5_1, . . . , N5_8 allocated to the inputs I4/NI4 and four N-channel transistors N6_1, . . . , N6_4 allocated to the inputs I5/NI5. The transistors Ni_j having an even index j are driven inverted whereas transistors having an odd index j are driven non-inverted.

The source terminals of the two transistors N1_1 and N1_2 are connected to K1. The source terminals of transistors N2_1 and N2_2 are connected to the drain terminal of transistor N1_1 and the source terminals of transistors N2_3 and N2_4 are connected to the drain terminal of transistor N1_2. The source terminals of the transistor pairs N3_1, N3_2 and, respectively, N3_3, N3_4 and, respectively, N3_5, N3_6 are connected to the drain terminals of transistors N2_1 and, respectively, N2_2 and N2_3 and, respectively, N2_4.

The source terminals of the transistor pairs N4_1, N4_2 and, respectively N4_3, N4_4 and, respectively, N4_5, N4_6 and, respectively, N4_7, N4_8 are connected to the drain terminals of the transistors N3_1 and, respectively, N3_2 and N3_3 and, respectively, N3_4 and N3_5 and, respectively, N3_6. The source terminals of the transistor pairs N5_1, N5_2 and, respectively, N5_3, N5_4 and, respectively, N5_5, N5_6 and, respectively, N5_7, N5_8 are connected to the drain terminals of transistors N4_1 and N4_8 and, respectively, N4_2 and N4_3 and, respectively N4_4 and N4_5 and, respectively, N4_6 and N4_7. The source terminals of transistors N6_1 and N6_2 are connected to the drain terminals of transistors N5_1 and N5_8 and the source terminals of transistors N6_3 and N6_4 are connected to the drain terminals of transistors N5_4 and N5_5. The junction K2 is connected to the drain terminals of transistors N6_2, N5_2, N5_3 and N6_3 and the junction K3 is connected to the drain terminals of transistors N6_1, N6_4, N5_6 and N5_7.

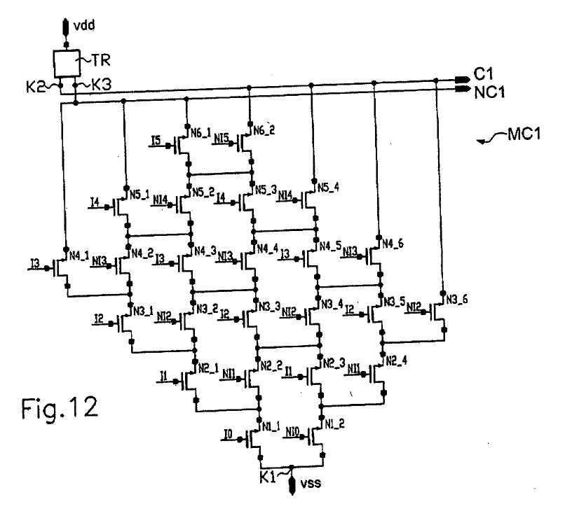

In the multitransistor circuit MC1 according to FIG. 12, two N-channel transistors N1_1, N1_2 are allocated to the inputs I0/NI0, four N-channel transistors N2_1, . . . , N2_4 are allocated to inputs I1/NI1, six N-channel transistors N3_1, . . . , N3_6 are allocated to inputs I2/NI2, six N-channel transistors N4_1, . . . , N4_6 are allocated to inputs I3/NI3, four N-channel transistors N5_1, . . . , N5_4 are allocated to inputs I4/NI4 and two N-channel transistors N6_1, N6_2 are allocated to inputs I5/NI5.

With respect to transistors NI_j, with i=1, 2, 3, 4, the multitransistor circuit MC1 is identical to the multitransistor circuit MC0, with the exception that there are no transistors N4_7 and N4_8. The source terminals of the transistor pairs N5_1, N5_2 and, respectively, N5_3, N5_4 are connected to the drain terminals of transistors N4_2 and N4_3 and, respectively, N4_4 and N4_5. The source terminals of the transistors N6_1 and N6_2 are connected to the drain terminals of transistors N5_2 and N5_3. The junction K2 is connected to the drain terminals of transistors N6_2, N5_4, N4_6 and N3_6 and the junction K3 is connected to the drain terminals of transistors N4_1, N5_1 and N6_1. Here, too, it applies that transistors Ni_j with an even index j are driven inverted whereas transistors having an odd index j are driven non-inverted.

The circuit according to the second exemplary embodiment can be driven in two different ways depending on the design of the driver circuit TR. In a first form of operation, which is outlined by the term “dynamic circuit technology”, the driver circuit TR is designed as a charging circuit which charges up the two junctions K2 and K3 to operating voltage vdd before a computing operation. As a result, the two outputs S, NS and, respectively, C0, NC0 and, respectively, C1, NC1 are precharged to vdd. During this precharge phase, the multitransistor circuits MS, MC0, MC1 must be driven in such a way that they have a high impedance, i.e. insulate the outputs with respect to vss.

After the junctions K2, K3 have been charged up, the driver circuit TR is switched to high impedance, i.e. the junctions K2 and K3 are disconnected from vdd.

In a next step, the transistors of the multitransistor circuits MS, MC0, MC1 are driven via the inputs I0/NI0, . . . , I5/NI5 as a result of which partial or selective discharge paths are formed through the multitransistor circuits MS, MC0, MC1 in accordance with the bit allocation to the inputs I0/NI0, . . . , I5/NI5. These cause the signals to be generated at the sum output S and the carry outputs C0 and C1 and at the corresponding inverted outputs NS, NC0 and NC1 within one discharge cycle.

The procedure according to the dynamic circuit technology described has a minimum power requirement and short signal transit times.

A second form of operation of the circuit shown in FIGS. 6 and 10 to 12 consists in providing a permanent current flow through the circuit. In this case, the driver circuit TR is used as series resistance which must be smaller than the resistance of the respective multitransistor circuit MS or MC0 or MC1 when it is cut off. In this variant, short signal transit times can also be achieved but the power consumption is higher than in the first variant. The advantageous factor compared with the first variant is, however, that short-term voltage losses at inputs I0/NI0, . . . , I5/NI5 can be compensated for during a computing operation whereas this is not possible in the first-mentioned variant (dynamic circuit technology) due to the irreversible discharge processes occurring there. This possibility of “correcting” a calculation result, falsified by disturbances or voltage drops, within one computing cycle, given in the second variant, can represent an advantage of the second variant compared with the first variant which has a lower power consumption due to the transient discharge currents.

We claim:

1. A carry-save adder for adding bits of the same weight, comprising:
six inputs for receiving six bits of in each case the same weight w, which are to be added,
one output for a sum bit of the weight w and two outputs for two carry bits of the weights 2w and 4w, and
three adder subblocks which are arranged in parallel with one another and are not interconnected, wherein the first adder subblock generates the sum bit, the second adder subblock generates the carry bit of weight 2w and the third adder subblock generates the carry bit of weight 4w, each adder subblock being built up from logic gates.

2. The carry-save adder as claimed in claim 1, wherein
a and in particular each adder subblock is implemented from a maximum of three series-connected logic gate stages.

3. The carry-save adder as claimed in claim 2, wherein
the first adder subblock comprises in the first stage three XOR gates, in the second stage one XOR gates receiving input signals from the first two XOR gates of the first stage and in the third stage one XOR gate which receiving input signals from the XOR gate of the second stage and from the third XOR gate of the first stage.

4. The carry-save adder as claimed in claim 2, wherein
the second and third adder subblock each comprise in the first stage a plurality of NAND gates generating a plurality of output signals, in the second stage a plurality of AND gates combining the signals from the first stage generating three output signals and in the third stage one NAND gate combining the three signals from the second stage.

5. The carry-save adder for adding bits of the same weight, comprising:
six inputs for receiving six bits of in each case the same weight w, which are to be added,
one output for a sum bit of the weight w and two outputs for two carry bits of weight 2w and 4w, and
three adder subblocks connected in parallel with one another and not interconnected, wherein the first adder subblock generates the sum bit, the second adder subblock generates the carry bit of weight 2w and the third adder subblock generates the carry bit of weight 4w, and each adder subblock consists of a multitransistor circuit which cannot be resolved into logic gates,
wherein in the multitransistor circuit which forms the adder subblock for calculating the sum bit, one input drives two and the remaining inputs drive four transistors.

6. The carry-save adder as claimed in claim 5, wherein
in the multitransistor circuit which forms the adder subblock for calculating the carry bit of weight 2w, a first input drives two transistors, a second and a third input in each case drive four transistors, a fourth input drives six transistors and a fifth and a sixth input in each case drive eight transistors.

7. The carry-save adder as claimed in claim 6, wherein
in the multitransistor circuit which forms the adder subblock for calculating the carry bit of weight 4w, a first and a second input in each case drive two transistors, a third and a fourth input in each case drive four transistors and a fifth and a sixth input in each case drive six transistors.

8. The carry-save adder as claimed in claim 5, comprising:
a charging circuit which is connected to the multitransistor circuit, in such a manner that it is discharged via the latter in dependence on the bits present at the inputs of the adder.
